(19) United States
(12) Patent Application Publication
(10) Pub. No.: US 2021/0303751 A1
(43) Pub. Date: Sep. 30, 2021

(54) METHOD AND DEVICE FOR RAPID ANALYSIS OF TUNNEL SECTION CONVERGENCE

(71) Applicant: Nanjing University of Aeronautics and Astronautics, Nanjing (CN)

(72) Inventors: Jun WANG, Nanjing (CN); Kun LONG, Nanjing (CN); Dening LU, Nanjing (CN)

(21) Appl. No.: 17/169,540

(22) Filed: Feb. 7, 2021

(30) Foreign Application Priority Data
Mar. 27, 2020 (CN) 202010228294.9

(51) Int. Cl. G06F 30/18; G06F 30/13; G06F 30/20; G06K 9/00

(52) U.S. Cl. CPC G06F 30/18; G06F 30/13; G06F 2111/10; G06K 9/00637; G06F 30/20

(57) ABSTRACT

A method for rapid analysis of tunnel section convergence including: S obtaining a three-dimensional point cloud of tunnel structure; S2, fitting a cylinder based on the three-dimensional point cloud of the tunnel structure to obtain a central axis of tunnel point cloud; S3, constructing a plane based on the central axis of the tunnel point cloud and a given point, and intercepting a section of the tunnel point cloud based on the plane; S4, determining a center of the section of the tunnel point cloud; S5, extracting outline point clouds at a fixed angle range on both sides of the section based on the center of the section, and performing circle fitting on the outline point clouds respectively to obtain two outline circles; and S6, carrying out analysis of section convergence according to centers and radii of the outline circles on both sides of the section.

### CROSS-REFERENCE TO RELATED APPLICATIONS

This application claims the benefit of priority from Chinese Patent Application No. 202010228294.9, filed on Mar. 27, 2020. The content of the aforementioned application, including any intervening amendments thereto, is incorporated herein by reference in its entirety.

### TECHNICAL FIELD

This application relates to tunnel section analysis technology, and more particularly to a method and device for rapid analysis of tunnel section convergence.

### BACKGROUND

The continuous development of cities brings increasing pressure on. surface road traffic. The subway is widely utilized to reduce the pressure on surface road traffic, and becomes one of the most popular public transportation due to its advantages of convenience, rapidity and high capacity. However, the long-term use of subway tunnel will cause problems such as aging and deformation, and newly-built buildings near the subway tunnel may also cause deformation of the tunnels. The aging and deformation of the tunnel may further lead to the collapse of the tunnel, which seriously endangers the lives and property safety of passengers, as well as the transportation system of entire city.

Manual detection commonly used for detecting the deformation of the tunnel does not meet the requirements for the development of modern urban rail transit due to its low accuracy and efficiency. Recently, three-dimensional (3D) laser scanning technology has been widely used in various measurement fields due to its high measurement accuracy and convenient operation, and can be applied to high-precision, high efficient and non-contact tunnel deformation detection.

Point cloud data processing based on 3D laser scanning is still in its infancy, and the section deformation is generally calculated by circle fitting and ellipse fitting. Chinese Patent Application No. 201711158016.5 disclosed a “Three-dimensional scanning method for subway detection and measurement”, in which the two-dimensional point cloud data of the tunnel was obtained by scanning, and the mileage data was synchronously collected; the two-dimensional point cloud data and the mileage data were matched to obtain the three-dimensional point cloud data of the tunnel; the three-dimensional point cloud data of the tunnel was sliced, and the ellipse fitting was performed after preprocessing the slice. Chinese Patent Application No. 201910182146.5 disclosed a “Method for extracting tunnel section of ground-based point cloud”, which included the following steps: (1) calculating and extracting center coordinates of the section; (2) determining the tunnel section equation; (3) determining the tunnel section ray equation; (4) determining the section point; (5) section fitting and re-sampling. This method adopted a cylindrical surface that better fits the shape of the tunnel surface to perform local fitting, which can overcome the noise influence of tunnel surface. This method can also adapt to different tunnel point cloud densities, and can smoothly extract tunnel section for non-uniform tunnel point clouds. At the same time, the extracted section points were further fitted and re-sampled to further adapt to the heterogeneity of the point cloud and to make up for the missing part of the point cloud to a certain extent.

However, it is difficult to quickly and accurately detect whether the section is deformed directly through circle fitting or ellipse fitting due to the irregular deformation of the tunnel section caused by aging or external forces and the influence of noise and outliers in the point cloud data.

In view of the difficulty in realizing tunnel deformation analysis quickly, accurately and efficiently in the prior art, no effective solution has been proposed yet.

### SUMMARY

An object of this application is to provide a method and device for rapid analysis of tunnel section convergence, which can effectively intercept the tunnel section to obtain the center of the section, and extract outline point clouds at a fixed angle range on a left side and a right side of the section based on the center of the section to perform circle fitting, and two outline circles can be obtained to quickly and accurately realize section convergence and tunnel deformation analysis.

The technical solutions of this application are described as follows.

In a first aspect, this application provides a method for rapid analysis of tunnel section convergence, comprising:
S1, obtaining a three-dimensional (3D) point cloud of a tunnel structure;
S2, fitting a cylinder based on the 3D point cloud of the tunnel structure to obtain a central axis of tunnel point cloud;
S3, constructing a plane based on the central axis of the tunnel point cloud and a given point, and intercepting a section of the tunnel point cloud based on the plane;
S4, determining a center of the section of the tunnel point cloud;
S5, extracting outline point clouds at a fixed angle range on a left side and a right side of the section based on the center of the section of the tunnel point cloud, and performing circle fitting on the outline point clouds respectively to obtain two outline circles; and
S6, carrying out analysis of section convergence according to centers and radii of the outline circles on both sides of the section.

In some embodiments, in step S1, the tunnel is scanned by a 3D laser scanner to obtain the 3D point cloud of the tunnel structure.

In some embodiments, the step S2 comprises:
S21, fitting a cylindrical outline of the tunnel point cloud based on the 3D point cloud of the tunnel structure using Gaussian mapping method; and
S22, defining a central axis of the cylinder as the central axis of the tunnel point cloud, and defining a direction vector of the central axis of the tunnel point cloud as \vec{τ}(A, B, C).

In some embodiments, the step S3 comprises:
S31, taking a direction of the central axis \vec{τ}(A, B, C) as a normal vector direction \vec{n}(A, B, C) based on the central axis of the tunnel point cloud; wherein A, B, and C are components of \vec{n} vector in x, y and z axis in an xyz space coordinate system, which are the same as A, B and C in \vec{τ}(A, B, C);
S32, giving a point S(x₀, y₀, z₀) in the tunnel point cloud and a known normal vector \vec{n}(A, B, C) to determine a plane Γ according to a plane parameter equation, where the plane parameter equation is:

A(x−x₀)+B(y−y₀)+C(z−z₀)=0;

and A, B, an C are the components of normal vector \vec{n}(A, B, C) of the plane Γ in x, y and z axis, and (x, y, z) indicates a coordinate of any point on the plane Γ in the xyz space coordinate system; and the plane Γ is perpendicular to the central axis of the tunnel point cloud; and
S33: intercepting the section of the tunnel point cloud based on the plane Γ to obtain a point cloud of tunnel section.

In some embodiments, the step S4 comprises:
preliminarily fitting the outline circle of the tunnel section by RANSAC circle fitting method based on the point cloud of tunnel section, and taking the center of the outline circle of the tunnel section as a center O of the tunnel section.

In some embodiments, the step S5 comprises:
S51, extracting outline point cloud P and outline point cloud Q at a preset angle range on the left side and the right side of the section based on the center O of the section;
S52, performing circle fitting on the outline point cloud P and the outline point cloud Q respectively to obtain two outline circles by RANSAC circle fitting method, where the centers of the two outline circles are c₁ and c₂, and the radii of the two outline circles are r₁ and r₂.

In some embodiments, the preset angle range is 30°-60°.

In some embodiments, the step S6 comprises:
S61, supposing the centers of the two outline circles c₁ and c₂, and the radius are r₁ and r₂;
S62, calculating tunnel section convergence analysis results d based on coordinates of the centers and radii of the two outline circles using following tunnel section convergence formula:

d=|c₁.x−c₂.x|+r₁+r₂;

where c₁.x is a coordinate of the center c₁ along an x axis, and c₂.x is a coordinate of the center c₂ along the x axis;
S63, comparing and analyzing the tunnel section convergence analysis results with the convergence threshold.

In a second aspect, this application provides a device for rapid analysis of tunnel section convergence based on the above method, comprising:
a data acquisition module configured to acquire the 3D point cloud of the tunnel structure;
a section extraction module configured to intercept a section of the tunnel point cloud based on the 3D point cloud of the tunnel structure;
a section convergence analysis module configured to calculate the section convergence of the tunnel point cloud and analyze the convergence results.

In some embodiments, the section extraction module comprises:
a preprocessing unit configured to fit the tunnel point cloud into a cylinder using Gaussian mapping and obtain the central axis of the tunnel point cloud, and determine the plane based on the central axis and the given point and intercept the section of the tunnel point cloud based on the plane;
a section fitting unit configured to preliminarily fit the point cloud of tunnel section into outline circle of the section, determine the center of the section, extract outline point clouds at the fixed angle range on the left side and the right side of the section based on the center of the section, and perform circle fitting on the outline point clouds respectively to obtain two outline circles, and record the radii and centers of the two outline circles.

Compared to the prior art, the present application has the following beneficial effects.

1. The section of the tunnel can be effectively intercepted to obtain the center of the section, and outline point clouds at a fixed angle range on a left side and a right side of the section based on the center of the section can be extracted to perform circle fitting. The deformation of the section and tunnel can be quickly and accurately analyzed based on the coordinates of the centers and radii of the two contour circles.

2. The shape of the tunnel section is unrestricted, which has wide applicability.

3. For some incomplete sections caused by incomplete point cloud data acquisition, the subsequent convergence analysis can be completed through circle fitting that has low dependence on the integrity of the point cloud data, and it has been proved that the analysis results are the same accurate as the results analyzed from the complete point cloud data.

It should be understood that all combinations of the aforementioned concepts and the additional concepts described in more detail below can be regarded as part of the present disclosure as long as such concepts are not mutually contradictory. In addition, all combinations of the claimed subject matter are regarded as part of the present disclosure.

The aforementioned concepts, embodiments and features of this disclosure can be more fully understood from the following description with reference to the accompanying drawings. Other additional aspects of this disclosure, such as the features and/or beneficial effects of the exemplary embodiments, will be apparent in the following description, or learned from the practice of the specific embodiments of this disclosure.

### BRIEF DESCRIPTION OF THE DRAWINGS

The drawings are not drawn to scale. In the drawings, each identical or nearly identical component shown in each figure may be represented by the same reference numeral, and not every component is labeled in every figure. The embodiments of this disclosure will be described with reference to the drawings.

FIG. 1 is a flow chart of a method for rapid analysis of tunnel section convergence according to an embodiment of the present disclosure.

FIG. 2 is a schematic diagram of a point cloud of a tunnel according to Embodiment 1 of the present disclosure.

FIG. 3 is a schematic diagram of a point cloud of a tunnel section according to Embodiment 1 of the present disclosure.

FIG. 4 is a schematic diagram of a fitted outline circle of a tunnel section according to Embodiment 1 of the present disclosure.

FIG. 5 is a schematic diagram of fitted outline circles on the left and right sides of the tunnel section according to Embodiment 1 of the present disclosure.

FIG. 6 is a schematic diagram of a device for rapid analysis of tunnel section convergence according to an embodiment of the present disclosure.

### DETAILED DESCRIPTION OF EMBODIMENTS

The invention will be further described below in detail with reference to the accompanying drawings and the embodiments.

### Embodiment 1

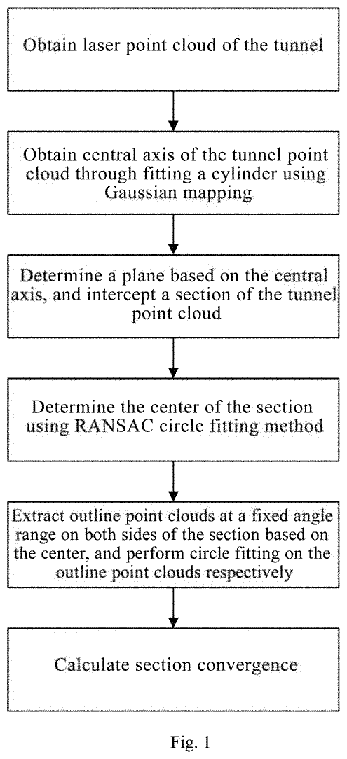

Compared to the traditional tunnel deformation analysis method, the method for rapid analysis of tunnel section convergence provided in this embodiment has high data processing accuracy, high work efficiency and wide application range, which can complete the effective analysis of tunnel deformation under the condition of less labors, materials and costs. A flow chart of this method is shown in FIG. 1, which includes the following steps:
S1, obtaining a three-dimensional (3D) point cloud of a tunnel structure through scanning a tunnel structure such as subway tunnel by a 3D laser scanner;
S2, extracting a central axis of tunnel point cloud based on the 3D point cloud of the tunnel structure;
S3, constructing a plane based on the central axis of the tunnel point cloud and a given point, and intercept a section of the tunnel point cloud based on the plane;
S4, fitting the outline circle of the tunnel section by RANSAC circle fitting method based on the point cloud of tunnel section, and determine a center of the tunnel section;
S5, extracting outline point clouds at a fixed angle range on a left side and a right side of the tunnel section based on the center of the tunnel section, perform circle fitting on the outline point clouds respectively to obtain two outline circles, and record the radii and centers of the two outline circles; and
S6, carrying out analysis of section convergence by section convergence calculation formula according to centers and radii of the outline circles on both sides of the section.

The method provides a rapid analysis for subway tunnel section convergence, which is realized in the following ways: obtain a 3D point cloud of a subway tunnel and extract central axis of the tunnel based on the point cloud; determine a section of the tunnel point cloud based on the central axis and a given point; fit a cylindrical outline of the section of the tunnel point cloud, and determine the center of the outline circle; extract outline point clouds at a fixed angle range on a left side and a right side of the section based on the center of the outline circle; perform circle fitting on the outline point clouds respectively to obtain two outline circles; calculate tunnel section convergence based on the centers and radii of the outline circles. The above method can quickly complete the calculation of the tunnel section convergence and realize the tunnel deformation detection rapidly and more effectively.

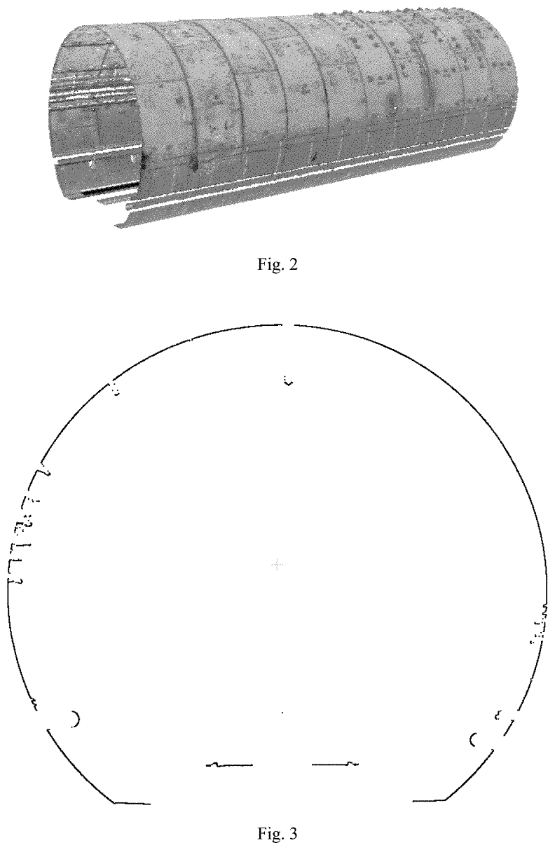

A point cloud of a subway tunnel is shown in FIG. 2, which contains a tunnel point cloud having 10 circles. The tunnel section is an approximate circle, and the tunnel section circle needs to be processed in the subsequent steps.

In this embodiment, extract the central axis of the tunnel point cloud based on the 3D point cloud data includes: fit a cylinder based on the 3D point cloud data of the tunnel using Gaussian mapping method, and take the central axis of the cylinder as the central axis of the tunnel point cloud.

The extraction of the central axis of the tunnel can be achieved by the following steps. Gaussian mapping is done to the tunnel point cloud, and a big circle composed of points perpendicular to the axis of the cylinder is obtained on the Gaussian sphere. Based on the points on the big circle, the ordinary least squares are used to fit the plane to obtain the normal vector of the plane. The direction of the normal vector of the plane is the direction of the central axis of the tunnel point cloud.

Furthermore, based on the direction of the central axis of the tunnel point cloud, a point in the tunnel point cloud is given, and a section of the tunnel point cloud is intercepted. Specifically, taking the direction of the central axis \vec{n}(A, B, C) as the normal vector direction based on the central axis of the tunnel point cloud, a plane Γ is determined according to a given point S(x₀, y₀, z₀) in the tunnel point cloud, and then a tunnel point cloud section is intercepted based on the plane. The linear equation is: A(x−x₀)+B(y−y₀)+C(z−z₀)=0.

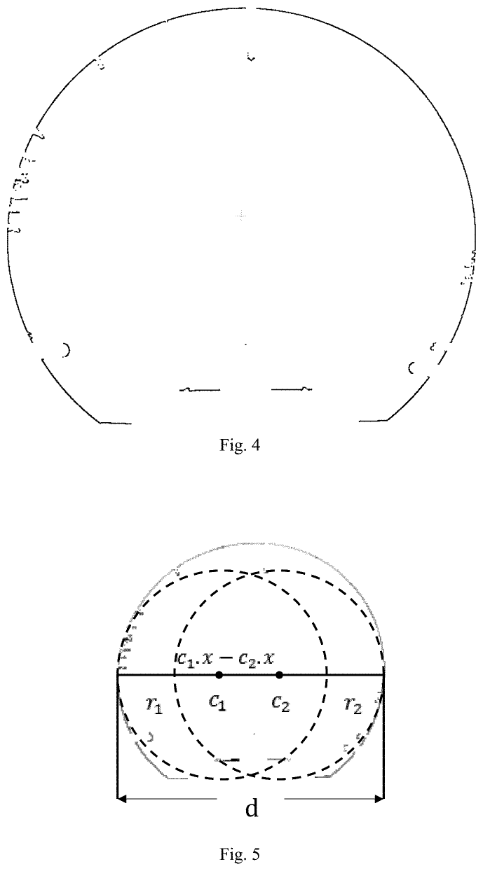

A point cloud of the tunnel section is shown in FIG. 3, after obtaining the point cloud of the tunnel section, the center of the tunnel section is further determined by using the RANSAC circle fitting method. The tunnel section circle is preliminarily fitted by using the RANSAC circle fitting method for the point cloud of the tunnel section, and the center O of the tunnel section circle is determined, as shown in FIG. 4.

After determining the center of the tunnel section, the outline point clouds on the left and right sides of the tunnel section is further extracted based on the center of the tunnel section for circle fitting. Specifically, based on the center of the tunnel section circle, the outline point clouds P and Q with an angle range of 30° to 60° are extracted to fit two complete circles by using the RANSAC circle fitting method for the point clouds P and Q respectively; and then the coordinates of the centers of the circles c₁ and c₂ and radii are determined, as shown in FIG. 5.

After obtaining the centers and radii of the outline circles on both sides of the tunnel section, the convergence calculation formula of the tunnel section is designed:

d=|c₁.x−c₂.x|+r₁+r₂;

then the rapid analysis of tunnel section convergence is completed.

### Embodiment 2

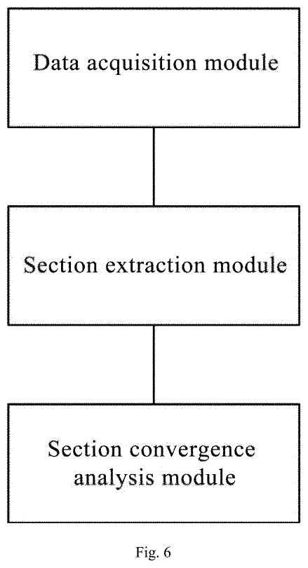

Based on the method for rapid analysis of tunnel section convergence provided in Embodiment 1, a subway tunnel image processing device is provided here. The structure block diagram of the device is shown in. FIG. 6, which includes:
(1) a data acquisition module configured to acquire the point cloud of the subway tunnel;
(2) a section extraction module connected to the data acquisition module, which is configured to extract the point cloud of the tunnel section in the point cloud of the subway tunnel; and
(3) a section convergence analysis module connected to the section extraction module, which is configured to calculate the section convergence of the subway tunnel section and rapidly analyze the deformation of the subway tunnel.

In the above embodiment, a rapid and accurate analysis method is provided for the convergence analysis of the subway tunnel section. The following operations are carried out to realize the analysis method. The 3D point cloud of the subway tunnel is obtained and the central axis of the tunnel is extracted based on the point cloud data. A section of the tunnel point cloud is determined based on the central axis and a given point. A cylindrical outline of the section of the tunnel point cloud is fitted based on the RASAC circle fitting method to determine the center of the outline circle. Outline point clouds at a fixed angle range on a left side and a right side of the section are extracted based on the center of the outline circle. Circle fitting is performed on the outline point clouds respectively to obtain two outline circles, from the centers and radii of which tunnel section convergence can be calculated. The above method can quickly complete the calculation of the tunnel section convergence and promote the efficiency and accuracy of the tunnel deformation analysis.

In some embodiments, the section extraction module includes;
(1) a preprocessing unit configured to fit the tunnel point cloud into a cylinder using Gaussian mapping and obtain the central axis of the tunnel point cloud, and determine the plane based on the central axis and the given point and intercept the section of the tunnel point cloud based on the plane;

(2) a section fitting unit configured to preliminarily fit the point cloud of tunnel section into outline circle of the section using RASAC circle fitting method, determine the center of the section, extract outline point clouds at the fixed angle range on the left side and the right side of the section based on the center of the section, and perform circle fitting on the outline point clouds respectively to obtain two outline circles, and record the radii and centers of the two outline circles.

Furthermore, the section convergence analysis module is configured to calculate the section convergence according to the formula and the coordinates of the centers and radii of the outline circles, and then compare and analyze the results with the convergence threshold.

The specific operations of each unit and module of the device have been described in detail in the embodiments of the method, and will not be elaborated here.

This disclosure is described with reference to the accompanying drawings, in which many illustrated embodiments are shown. The embodiments of the present disclosure are not necessarily defined to include all aspects of the present invention. It should be understood that the various concepts and embodiments introduced above, as well as those described in more detail below, can be implemented in various ways, because the concepts and embodiments disclosed in the present invention are not limited to any implementations. In addition, some aspects disclosed in the present invention can be used alone or in any appropriate combination with other aspects disclosed in the present invention.

Although the present invention has been described as above in preferred embodiments, it is not intended to limit the scope of the present invention. Those skilled in the art can make various changes and modifications without departing from the spirit and scope of the present invention. Therefore, the protection scope of the present invention shall be subject to those defined by the claims.

What is claimed is:

1. A method for rapid analysis of tunnel section convergence, comprising:
S1, obtaining a three-dimensional (3D) point cloud of a tunnel structure;
S2, fitting a cylinder based on the 3D point cloud of the tunnel structure to obtain a central axis of tunnel point cloud;
S3, constructing a plane based on the central axis of the tunnel point cloud and a given point, and intercepting a section of the tunnel point cloud based on the plane;
S4, determining a center of the section of the tunnel point cloud;
S5, extracting outline point clouds at a fixed angle range on a left side and a right side of the section based on the center of the section of the tunnel point cloud, and performing circle fitting on the outline point clouds respectively to obtain two outline circles; and
S6, carrying out analysis of section convergence according to centers and radii of the outline circles on both sides of the section.

2. The method of claim 1, wherein in step S1, the tunnel is scanned by a 3D laser scanner to obtain the 3D point cloud of the tunnel structure.

3. The method of claim 1, wherein the step S2 comprises:
S21, fitting a cylindrical outline of the tunnel point cloud based on the 3D point cloud of the tunnel structure using Gaussian mapping method; and
S22, defining a central axis of the cylinder as the central axis of the tunnel point cloud, and defining a direction vector of the central axis of the tunnel point cloud as \vec{τ}(A, B, C).

4. The method of claim 1, wherein the step S3 comprises:
S31, taking a direction of the central axis \vec{τ}(A, B, C) as a normal vector direction \vec{n}(A, B, C) based on the central axis of the tunnel point cloud; wherein A, B, and C are components of \vec{n} vector in x, y and z axis in an xyz space coordinate system, which are the same as A, B and C in \vec{τ}(A, B, C);
S32, giving a point S(x₀, y₀, z₀) in the tunnel point cloud and a known normal vector \vec{n}(A, B, C) to determine a plane Γ according to a plane parameter equation shown as follows:
A(x−x₀)+B(y−y₀)+C(z−z₀)=0;
wherein A, B, and C are the components of normal vector \vec{n}(A, B, C) of the plane Γ in x, y and z axis, and (x, y, z) indicates a coordinate of any point on the plane Γ in the xyz space coordinate system; and the plane Γ is perpendicular to the central axis of the tunnel point cloud; and
S33: intercepting the section of the tunnel point cloud based on the plane Γ to obtain a point cloud of tunnel section.

5. The method of claim 1, wherein the step S4 comprises:
preliminarily fitting the outline circle of the tunnel section by RANSAC circle fitting method based on the point cloud of tunnel section, and taking the center of the outline circle of the tunnel section as a center O of the tunnel section.

6. The method of claim 1, wherein the step S5 comprises:
S51, extracting outline point cloud P and outline point cloud Q at a preset angle range on the left side and the right side of the section based on the center O of the section; and
S52, performing circle fitting on the outline point cloud P and the outline point cloud Q respectively to obtain two outline circles by RANSAC circle fitting method, where the centers of the two outline circles are c₁ and c₂, and the radii of the two outline circles are r₁ and r₂.

7. The method of claim 6, wherein the preset angle range 30°-60°.

8. The method of claim 1, wherein the step S6 comprises:
S61, supposing the centers of the two outline circles c₁ and c₂ each having radius of r₁ and r₂;
S62, calculating tunnel section convergence analysis results d based on coordinates of the centers and radii of the two outline circles using following tunnel section convergence formula:
d=|c₁.x−c₂.x|+r₁+r₂;
where c₁.x is a coordinate of the center c₁ along an x axis, and c₂.x is a coordinate of the center c₂ along the x axis; and
S63, comparing and analyzing the tunnel section convergence analysis results with the convergence threshold.

9. A device for rapid analysis of tunnel section convergence based on the method of claim 1, comprising:
a data acquisition module configured to acquire the 3D point cloud of the tunnel structure;
a section extraction module configured to intercept a section of the tunnel point cloud based on the 3D point cloud of the tunnel structure; and
a section convergence analysis module configured to calculate the section convergence of the tunnel point cloud and analyze the convergence results.

10. The device of claim 9, wherein the section extraction module comprises:
a preprocessing unit configured to: fit the tunnel point cloud into a cylinder using Gaussian mapping and obtain the central axis of the tunnel point cloud, and determine the plane based on the central axis and the given point and intercept the section of the tunnel point cloud based on the plane; and
a section fitting unit configured to: preliminarily fit the point cloud of tunnel section into outline circle of the section, determine the center of the section, extract outline point clouds at the fixed angle range on the left side and the right side of the section based on the center of the section, and perform circle fitting on the outline point clouds respectively to obtain two outline circles, and record the radii and centers of the two outline circles.
